(19) United States
(12) Patent Application Publication
(10) Pub. No.: US 2026/0112746 A1
(43) Pub. Date: Apr. 23, 2026

(54) Secondary Battery and Method of Manufacturing Secondary Battery

(71) Applicant: SK On Co., Ltd., Seoul (KR)

(72) Inventors: Seung Ho KWAK, Daejeon (KR); Soo Min PARK, Daejeon (KR); Jae Yun PARK, Daejeon (KR); Joo Hyuk LEE, Daejeon (KR); Myeong Shin CHO, Daejeon (KR); Soo In PARK, Gyeonggi-do (KR)

(21) Appl. No.: 19/356,283

(22) Filed: Oct. 13, 2025

(30) Foreign Application Priority Data
Oct. 18, 2024 (KR) 10-2024-0142739

(51) Int. Cl. H01M 50/169; H01M 10/04; H01M 50/107; H01M 50/152; H01M 50/538; H01M 50/567; H01M 50/645

(52) U.S. Cl. CPC H01M 50/169; H01M 10/049; H01M 50/107; H01M 50/152; H01M 50/538; H01M 50/567; H01M 50/645

(57) ABSTRACT

Provided are a secondary battery and a method of manufacturing the secondary battery. According to one aspect of the present disclosure, the secondary battery includes a can, an electrode assembly disposed inside the can, a rivet disposed on one surface of the can and electrically connected to a first electrode tab of the electrode assembly, and a cap plate disposed on a surface opposite to the one surface, fastened to the can to close an opening of the can, and electrically connected to a second electrode tab of the electrode assembly, wherein the cap plate includes a bonding region directly welded to the second electrode tab, wherein the cap plate has at least a portion of the remaining area excluding the joining region with a first thickness, and wherein the bonding region has at least a portion with a second thickness smaller than the first thickness.

### CROSS-REFERENCE TO RELATED APPLICATION

The present application claims priority to and the benefit of Korean Patent Application No. 10-2024-0142739, filed on Oct. 18, 2024 in the Korean Intellectual Property Office, the entire disclosure of which is incorporated herein by reference.

### BACKGROUND

### 1. Field of the Invention

Embodiments of the present disclosure relate to a secondary battery and a method of manufacturing the secondary battery.

### 2. Discussion of Related Art

A secondary battery is known as one type of energy storage means that can be charged and discharged through an electrochemical reaction. The secondary battery is widely used in various fields using electrical energy. For example, the secondary battery is widely used in the field of mobile devices such as mobile phones, laptops, and tablets, and broader use is being sought in the field of transportation means such as vehicles, aircraft, and ships. In addition, demand for secondary batteries is increasing in the field of energy storage systems (ESSs) for utilizing surplus power.

The secondary batteries may be classified into a pouch type, a prismatic type, a cylindrical type, a coin type, and the like depending on the packaging form. Demand for cylindrical secondary batteries has been rapidly increasing in recent years in the vehicle field due to their relatively low manufacturing costs. The cylindrical secondary battery may have a structure in which a jelly roll-type electrode assembly is accommodated in a can together with an electrolyte. The electrode assembly may have a structure in which a positive electrode and a negative electrode having a sheet form are disposed with a separator interposed therebetween and wound into a roll shape.

As the demand for secondary batteries increases in various fields, the industry is actively exploring ways to improve the manufacturing cost or convenience of secondary batteries. For example, cylindrical secondary batteries used in the vehicle field are gradually increasing in size, and ways to improve manufacturing cost or convenience are being explored in response. Furthermore, despite improvements in manufacturing cost or convenience, the quality or performance of secondary batteries needs to be appropriately maintained.

### SUMMARY OF THE INVENTION

Some embodiments of the present disclosure are directed to providing a secondary battery and a method of manufacturing the secondary battery.

Some embodiments of the present disclosure are also directed to providing a secondary battery and a method of manufacturing the secondary battery that can reduce manufacturing costs.

Some embodiments of the present disclosure are also directed to providing a secondary battery and a method of manufacturing the secondary battery that can reduce assembly defects.

At least some embodiments of the present disclosure may be widely applied in the field of green technology such as an electric vehicle, a battery charging station, and solar power generation and wind power generation utilizing batteries. In addition, at least some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery including a can, an electrode assembly disposed inside the can, a rivet disposed on one surface of the can and electrically connected to a first electrode tab of the electrode assembly and a cap plate disposed on a surface opposite to the one surface, fastened to the can to close an opening of the can, and electrically connected to a second electrode tab of the electrode assembly, wherein the cap plate includes a bonding region welded to the second electrode tab, wherein the cap plate has at least a portion of the remaining area excluding the joining region with a first thickness, and wherein the bonding region has at least a portion with a second thickness smaller than the first thickness.

In some embodiments, the can may be charged with the same polarity as the second electrode tab and the cap plate.

In some embodiments, a plurality of first electrode tabs and a plurality of second electrode tabs may be provided, the plurality of first electrode tabs may provide a first bonding surface on one surface of the electrode assembly, and the plurality of second electrode tabs may provide a second bonding surface on a surface opposite to the one surface of the electrode assembly.

In some embodiments, at least a portion of the second bonding surface may be welded to the bonding region.

In some embodiments, the rivet may function as a first electrode terminal, and one surface of the can on which the rivet is disposed may be electrically insulated from the rivet such that at least a portion thereof may function as a second electrode terminal.

In some embodiments, the cap plate may be provided by processing a plate-shaped member having the first thickness, and the bonding region may be provided by press-forming a partial region of the cap plate corresponding to the bonding region to the second thickness.

In some embodiments, the bonding region may have a predetermined width in a radial direction centered on a central axis of the electrode assembly.

In some embodiments, the bonding region may be disposed at a predetermined interval in a radial direction from a central axis of the electrode assembly, and may be disposed at a predetermined interval in the radial direction from an outer peripheral end of the electrode assembly toward the central axis.

In some embodiments, the bonding region may be disposed at an interval of 10 to 40% of a radius of the electrode assembly from the central axis of the electrode assembly, and disposed at an interval of 10 to 40% of the radius of the electrode assembly from the outer peripheral end of the electrode assembly.

In some embodiments, the bonding region may be provided to extend in a circumferential direction centered on a central axis of the electrode assembly.

In some embodiments, the bonding region may include an inner surface disposed toward an inside of the can and an outer surface disposed toward an outside of the can and forming the second thickness between the inner surface and the outer surface, welding heat may be applied to the outer surface by a welding device, and the inner surface may be bonded to the second electrode tab according to the applied welding heat.

In some embodiments, a metal layer made of a material different from a material of the bonding region may be provided on the inner surface, and at least a portion of the metal layer may be melted by the applied heat and bonded to the second electrode tab.

In some embodiments, the metal layer may include a material corresponding to the second electrode tab and may be provided on the inner surface by coating, plating, or rolling.

In some embodiments, the secondary battery may further include a reinforcement member additionally fastened to an outer surface of the bonding region after the bonding region is welded to the second electrode tab,

In some embodiments, the reinforcement member may have at least a portion with a third thickness greater than the second thickness.

In some embodiments, the cap plate may include an inlet for injecting an electrolyte into the can, and the reinforcement member may be integrally provided with a plug for closing the inlet.

According to another aspect of the present disclosure, there is provided a method of manufacturing a secondary battery including (A) inserting an electrode assembly into a can through an opening, (B) electrically connecting a rivet disposed on one surface of the can to a first electrode tab of the electrode assembly, (C) closing the opening with a cap plate, and (D) electrically connecting a bonding region of the cap plate to a second electrode tab of the electrode assembly by welding, wherein the cap plate has at least a portion of the remaining area excluding the joining region with a first thickness, and wherein the bonding region has at least a portion with a second thickness smaller than the first thickness.

In some embodiments, operation (D) may include applying welding heat to an outer surface of the bonding region by a welding device, and bonding an inner surface of the bonding region to the second electrode tab according to the applied welding heat.

In some embodiments, the bonding region may include an inner surface disposed toward an inside of the can, a metal layer made of a material different from a material of the bonding region is provided on the inner surface, and operation (D) includes applying welding heat to an outer surface of the bonding region by a welding device, and melting at least a portion of the metal layer by the applied welding heat to be bonded to the second electrode tab.

In some embodiments, the method may further include, after operation (D), additionally fastening a reinforcement member to an outer surface of the bonding region.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings, in which:

FIG. 1 is a schematic perspective view of a secondary battery according to one embodiment of the present disclosure;

FIG. 2 is a schematic longitudinal cross-sectional view of the secondary battery illustrated in FIG. 1;

FIG. 3 is a schematic perspective view of an electrode assembly illustrated in FIG. 2;

FIG. 4 is a schematic enlarged view of a cap plate illustrated in FIG. 2;

FIG. 5 is a schematic exploded view of the cap plate separated from the can in FIG. 4;

FIG. 6 is a schematic plan view of the cap plate illustrated in FIG. 4;

FIG. 7 is a schematic plan view illustrating another embodiment of the cap plate illustrated in FIG. 6;

FIG. 8 is a schematic longitudinal cross-sectional view illustrating an embodiment in which a reinforcement member is added to a bonding region illustrated in FIG. 4;

FIG. 9 is a schematic longitudinal cross-sectional view illustrating another embodiment of the reinforcement member illustrated in FIG. 8;

FIG. 10 is a schematic longitudinal cross-sectional view illustrating an embodiment in which a metal layer is added to the bonding region illustrated in FIG. 4;

FIG. 11 is a first operational view illustrating a method of manufacturing the secondary battery according to one embodiment of the present disclosure;

FIG. 12 is a second operational view illustrating the method of manufacturing the secondary battery according to one embodiment of the present disclosure; and

FIG. 13 is a third operational view illustrating the method of manufacturing the secondary battery according to one embodiment of the present disclosure.

### DETAILED DESCRIPTION OF EXEMPLARY EMBODIMENTS

Hereinafter, the present disclosure will be described in detail with reference to the accompanying drawings. However, the following description is merely exemplary and is not intended to limit the present disclosure to the specific embodiments illustrated.

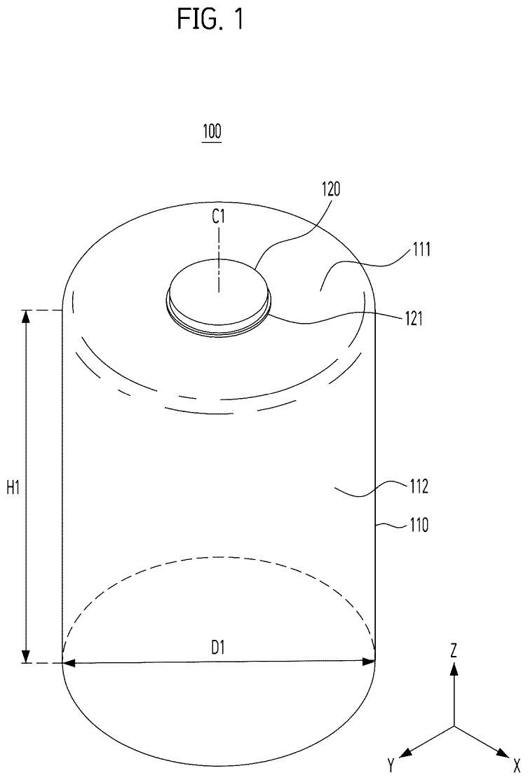

FIG. 1 is a schematic perspective view of a secondary battery according to one embodiment of the present disclosure;

For convenience of description, hereinafter, based on the coordinate axes shown in FIG. 1, an x-axis direction is referred to as a left-right direction, a y-axis direction is referred to as a front-rear direction, and a z-axis direction is referred to as an up-down direction. In addition, based on a central axis C1 illustrated in FIG. 1, a rotational direction around the central axis C1 is referred to as a circumferential direction, and the direction extending from the central axis C1 toward an outer surface of the secondary battery is referred to as a radial direction.

Referring to FIG. 1, in some embodiments, a secondary battery 100 may be formed in a cylindrical shape. The cylindrical secondary battery 100 may have a predetermined diameter D1 and height H1. For example, the secondary battery 100 may have a diameter of approximately 46 mm and a height of approximately 80 mm. In some cases, the secondary battery 100 having such a form factor may be referred to as a ‘4680 battery.’ In another example, the secondary battery 100 may have a diameter of approximately 46 mm and a height of approximately 80 mm, a diameter of approximately 46 mm and a height of approximately 95 mm, or a diameter of approximately 46 mm and a height of approximately 110 mm. In some cases, the secondary battery 100 having such a form factor may be referred to as a ‘46xx battery,’ where ‘xx’ denotes the height of the form factor. In another example, the secondary battery 100 may have a diameter of approximately 48 mm and a height of approximately 75 mm, a diameter of approximately 48 mm and a height of approximately 80 mm, or a diameter of approximately 48 mm and a height of approximately 110 mm. In some cases, the secondary battery 100 having such a form factor may be referred to as a ‘48xx battery,’ where ‘xx’ denotes the height of the form factor. However, the diameter D1 and the height H1 of the secondary battery 100 may vary as needed, and are not limited to the illustrated examples.

Meanwhile, although the cylindrical secondary battery 100 is exemplified in the present description, the form factor of the secondary battery 100 is not limited to the cylindrical shape. The secondary battery 100 according to embodiments of the present disclosure may be implemented or applied in various form factors such as a coin type, a prismatic type, or a pouch type within the scope of the technical ideas described below.

In some embodiments, the cylindrical secondary battery 100 may include a central axis C1. The central axis C1 may be formed as an imaginary axis vertically passing through the center of the secondary battery 100.

In some embodiments, the secondary battery 100 may include a can 110. The can 110 may form the exterior of the secondary battery 100 and may form an internal space for arranging an electrode assembly 130 described below. The can 110 may include an upper surface 111 and a side surface 112. The side surface 112 may be formed to extend in a circumferential direction centered on the central axis C1. In addition, a lower side of the can 110 may be open. The open lower side of the can 110 may be closed by a cap plate 150 described below.

In some embodiments, the secondary battery 100 may include a rivet 120. The rivet 120 may be disposed on the center of the upper surface 111 of the can 110. The rivet 120 may be electrically insulated from the can 110. To this end, a gasket 121 may be provided between the rivet 120 and the upper surface 111 of the can 110. The gasket 121 may be formed to electrically insulate the rivet 120 from the can 110 and mechanically seal the rivet 120 and the can 110. In some embodiments, the rivet 120 may function as an electrode terminal. For example, the rivet 120 may function as a positive electrode terminal or a negative electrode terminal. In the present description, the rivet 120 is described as a first electrode terminal. The first electrode terminal may be, for example, a positive electrode terminal.

In some embodiments, the can 110 may function as the other electrode terminal opposite to the rivet 120. For example, a partial region of the upper surface 111 of the can 110 may function as the other electrode terminal opposite to the rivet 120. In other words, a partial region of the upper surface 111 of the can 110 may function as a negative electrode terminal or a positive electrode terminal opposite to the rivet 120. In the present description, a partial region of the upper surface 111 of the can 110 is described as a second electrode terminal. The second electrode terminal may be, for example, a negative electrode terminal.

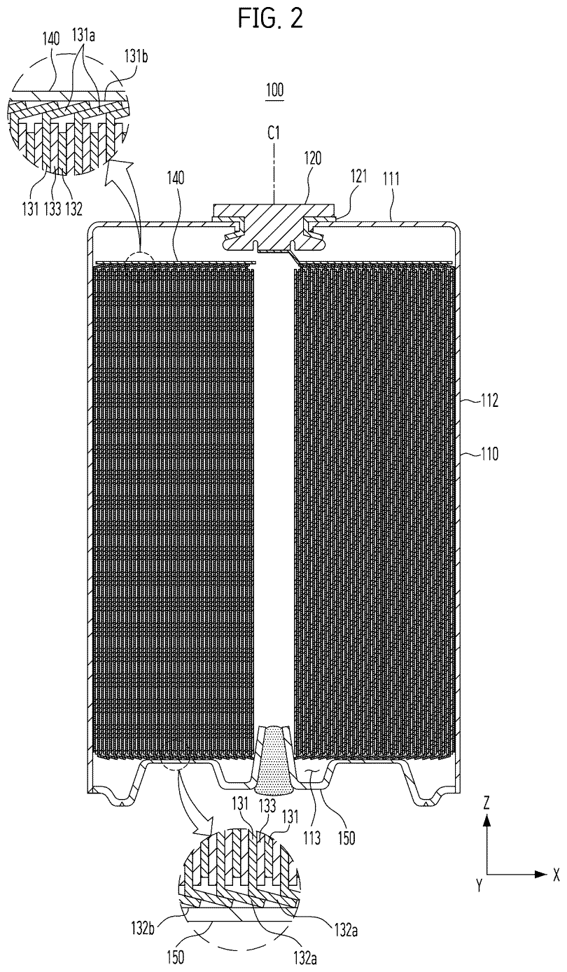

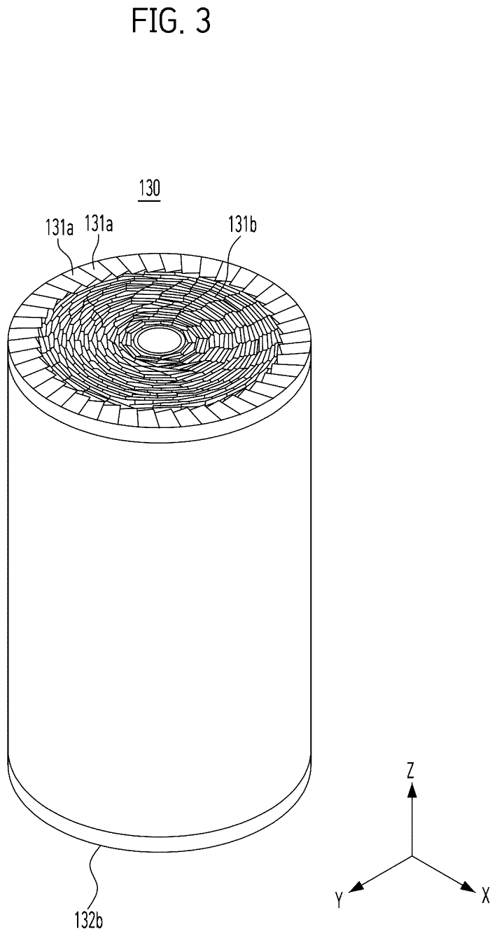

FIG. 2 is a schematic longitudinal cross-sectional view of the secondary battery illustrated in FIG. 1. FIG. 3 is a schematic perspective view of an electrode assembly illustrated in FIG. 2.

Referring to FIGS. 2 and 3, in some embodiments, the secondary battery 100 may include the electrode assembly 130. The electrode assembly 130 may be disposed inside the can 110. In some embodiments, the electrode assembly 130 may include a first electrode 131 and a second electrode 132 disposed with a separator 133 interposed therebetween. The first electrode 131 may be a positive electrode or negative electrode, and the second electrode 132 may be a negative electrode or positive electrode opposite to the first electrode 131. In the present description, the first electrode 131 is a positive electrode, and the second electrode 132 is a negative electrode.

In some embodiments, the first electrode 131 may include a positive electrode current collector and a positive electrode mixture layer disposed on at least one surface of the positive electrode current collector. For example, the positive electrode current collector may include aluminum, stainless steel, nickel, titanium, or an alloy thereof. Alternatively, the positive electrode current collector may include aluminum or stainless steel surface-treated with carbon, nickel, titanium, or silver. In some embodiments, the positive electrode mixture layer may include a positive electrode active material. The positive electrode active material may include a compound capable of reversibly intercalating and deintercalating lithium ions. For example, the positive electrode active material may include a lithium-nickel metal oxide. In some cases, the lithium-nickel metal oxide may further include at least one of cobalt, manganese, and aluminum. In some cases, the positive electrode mixture layer may further include a binder, and may optionally further include a conductive material, a thickener, and the like.

In some embodiments, the second electrode 132 may include a negative electrode current collector and a negative electrode mixture layer disposed on at least one surface of the negative electrode current collector. For example, the negative electrode current collector may include copper, stainless steel, nickel, titanium, nickel foam, copper foam, or a polymer substrate coated with a conductive metal. In some embodiments, the negative electrode mixture layer may include a negative electrode active material. The negative electrode active material may include a compound capable of reversibly intercalating and deintercalating lithium ions. For example, the negative electrode active material may include: a carbon-based material such as crystalline carbon, amorphous carbon, a carbon composite, or carbon fibers; lithium metal; a lithium alloy; a silicon-containing material; or a tin-containing material. In some cases, the negative electrode mixture layer may further include a binder, and may optionally further include a conductive material, a thickener, and the like.

The separator 133 may be disposed between the first electrode 131 and the second electrode 132. The separator 133 may limit an electrical short-circuit between the first electrode 131 and the second electrode 132 and may be configured to allow ions to flow. In some embodiments, the separator 133 may include a porous polymer film or a porous nonwoven fabric. For example, the porous polymer film may include a polyolefin-based polymer such as an ethylene polymer, a propylene polymer, an ethylene/butene copolymer, an ethylene/hexene copolymer, or an ethylene/methacrylate copolymer. In addition, the porous nonwoven fabric may include high-melting-point glass fibers or polyethylene terephthalate fibers. In some cases, the separator 133 may include a ceramic material. For example, the separator 133 may be formed by coating inorganic particles on the polymer film or dispersing the inorganic particles in the polymer film. In some cases, the separator 133 may have a single-layer or multilayer structure including the polymer film and/or the nonwoven fabric.

In some embodiments, the electrode assembly 130 may have a cylindrical roll shape in which the first electrode 131, the second electrode 132, and the separator 133 are wound around the central axis C1. In some cases, the electrode assembly 130 wound in the roll shape may be referred to as a jelly roll.

In some embodiments, the electrode assembly 130 may include a first electrode tab 131a. The first electrode tab 131a may extend from the first electrode 131. In some embodiments, the first electrode tab 131a may be provided at one end portion of the positive electrode current collector in which the positive electrode mixture layer is omitted. In the illustrated embodiment, the first electrode tab 131a is provided at an upper portion of the first electrode 131.

In some embodiments, a plurality of first electrode tabs 131a may be provided. The plurality of first electrode tabs 131a may be disposed in a winding direction of the first electrode 131. That is, the plurality of first electrode tabs 131a may be disposed in a longitudinal direction in which the first electrode 131 is wound.

In some embodiments, the plurality of first electrode tabs 131a may be bent toward the central axis C1. As illustrated in FIG. 3, the plurality of first electrode tabs 131a bent toward the central axis C1 may form a predetermined bonding surface 131b on an upper surface of the electrode assembly 130. For convenience of description, the bonding surface 131b is hereinafter referred to as the first bonding surface 131b. The first bonding surface 131b may be formed as an approximate surface formed by the plurality of first electrode tabs 131a bent toward the central axis C1.

In some embodiments, the first electrode tab 131a may be electrically connected to the rivet 120 through a current collector plate 140. The current collector plate 140 may be disposed between the first electrode tab 131a and the rivet 120. The current collector plate 140 may be welded to the first electrode tab 131a at the first bonding surface 131b to be electrically connected to the first electrode tab 131a. In addition, a central region of the current collector plate 140 may be welded to a lower end of the rivet 120 to be electrically connected to the rivet 120.

In some embodiments, the electrode assembly 130 may include a second electrode tab 132a. The second electrode tab 132a may extend from the second electrode 132. In some embodiments, the second electrode tab 132a may be provided at one end portion of the negative electrode current collector in which the negative electrode mixture layer is omitted. In the illustrated embodiment, the second electrode tab 132a is provided at a lower end portion of the second electrode 132.

Similar to the above-described first electrode tab 131a, a plurality of second electrode tabs 132a may be provided, and the plurality of second electrode tabs 132a may be disposed in a direction in which the second electrode 132 is wound. In addition, the plurality of second electrode tabs 132a may be bent toward the central axis C1. The plurality of second electrode tabs 132a bent toward the central axis C1 may form a second bonding surface 132b.

In some embodiments, the second electrode tab 132a may be electrically connected to the cap plate 150. Unlike the above-described first electrode tab 131a, the second electrode tab 132a may be directly coupled to the cap plate 150. That is, the second electrode tab 132a may be directly welded to the cap plate 150 to be electrically connected to the cap plate 150. Accordingly, the cap plate 150 and the can 110 may be electrically connected to the second electrode tab 132a and the second electrode 132.

In some embodiments, the secondary battery 100 may include the cap plate 150. The cap plate 150 may close an opening 113 of a lower side of the can 110. In some embodiments, the cap plate 150 may be welded to a lower end of the can 110 to be joined to the can 110. The inside of the can 110, with the electrode assembly 130 accommodated therein, may be properly sealed by the rivet 120 on the upper side and the cap plate 150 on the lower side.

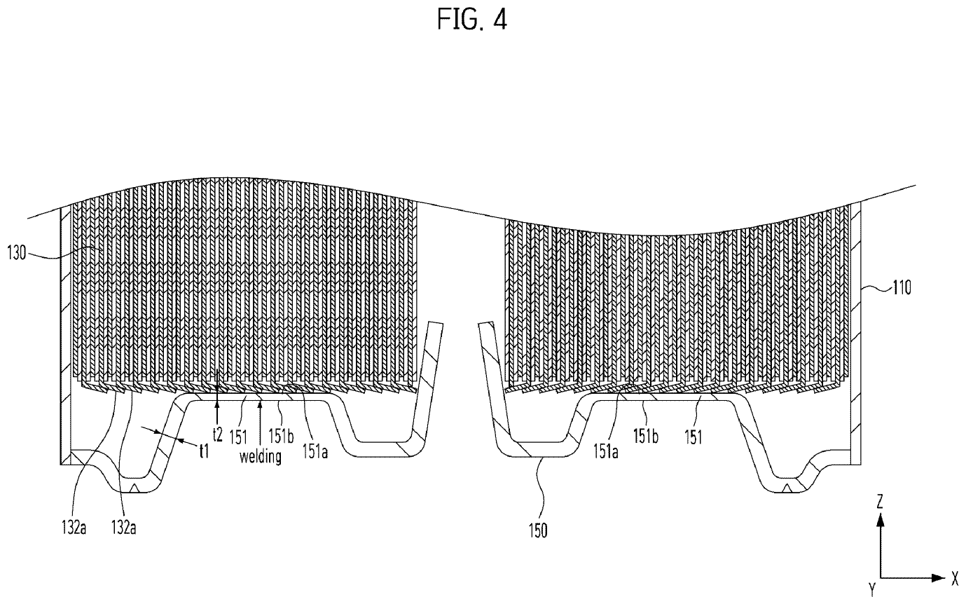

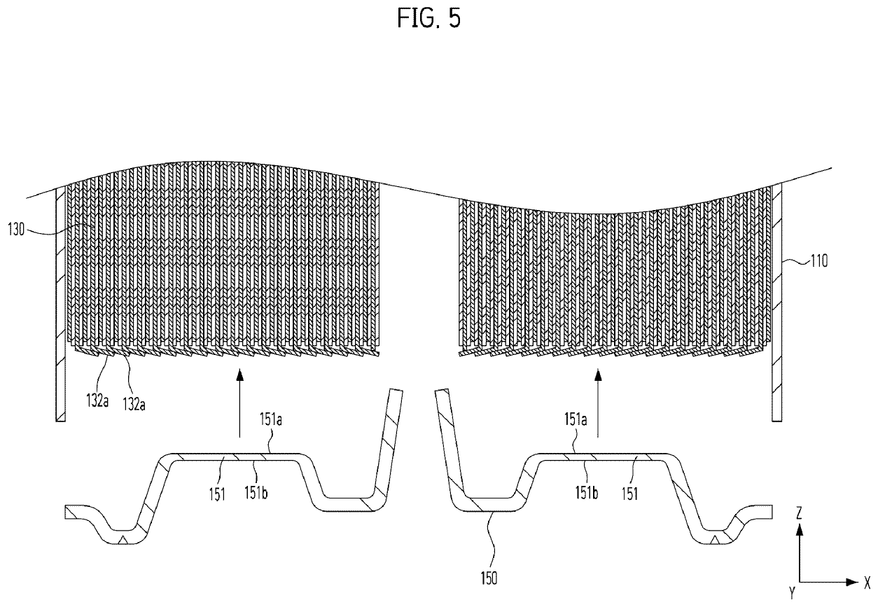

FIG. 4 is a schematic enlarged view of a cap plate illustrated in FIG. 2. FIG. 5 is a schematic exploded view of the cap plate separated from the can in FIG. 4.

Referring to FIGS. 4 and 5, in some embodiments, the secondary battery 100 may include the can 110. The secondary battery 100 may also include the electrode assembly 130 disposed inside the can 110. The secondary battery 100 may also include the rivet 120 disposed on one surface of the can 110 and electrically connected to the first electrode tab 131a of the electrode assembly 130. The secondary battery 100 may also include the cap plate 150 disposed on the surface opposite to the one surface, fastened to the can 110 to close the opening 113 of the can 110, and electrically connected to the second electrode tab 132a of the electrode assembly 130.

Here, the cap plate 150 may include a bonding region 151 welded to the second electrode tab 132a. Also, the cap plate 150 may be formed such that at least a portion of the remaining region excluding the bonding region 151 has a first thickness t1. The bonding region 151 may also be formed such that at least a portion thereof has a second thickness t2 smaller than the first thickness t1.

Specifically, in some embodiments, the secondary battery 100 may include the can 110. As described above, the can 110 may accommodate the electrode assembly 130 therein.

In some embodiments, the can 110 may be charged with the same polarity as the second electrode tab 132a and the cap plate 150. Specifically, the second electrode tab 132a may be electrically connected to the cap plate 150 through the bonding region 151, and the cap plate 150 may in turn be electrically connected to the can 110. Accordingly, the second electrode tab 132a, the cap plate 150, and the can 110 may be charged with the same polarity. For example, the second electrode tab 132a, the cap plate 150, and the can 110 may be charged as a negative electrode.

Meanwhile, in some embodiments, the secondary battery 100 may include the electrode assembly 130. As described above, the electrode assembly 130 may be accommodated inside the can 110. The electrode assembly 130 may also include the first electrode tab 131a on one surface (top surface) thereof, and the second electrode tab 132a on the opposite surface (bottom surface) thereof.

In some embodiments, there may be a plurality of first electrode tabs 131a and second electrode tabs 132a. The plurality of first electrode tabs 131a may also form the first bonding surface 131b on one surface (top surface) of the electrode assembly 130, and the plurality of second electrode tabs 132a may form the second bonding surface 132b on the opposite surface (bottom surface) of the one surface.

In some embodiments, the first bonding surface 131b may be electrically connected to the rivet 120 through the current collector plate 140 as described above. At least a portion of the second bonding surface 132b may be welded to the bonding region 151. The second bonding surface 132b may be electrically connected directly to the bonding region 151 without the current collector plate.

Meanwhile, in some embodiments, the secondary battery 100 may include the rivet 120. In some embodiments, the rivet 120 may function as a first electrode terminal. For example, the rivet 120 may function as a positive electrode terminal. In addition, the one surface (top surface) of the can 110 on which the rivet 120 is disposed may be electrically insulated from the rivet 120, and at least a portion thereof may function as a second electrode terminal. For example, a region of the upper surface 111 of the can 110 on which the rivet 120 is disposed may function as a negative electrode terminal. The rivet 120 that functions as a first electrode terminal and the region of the upper surface 111 of the can 110 that functions as a second electrode terminal may be electrically insulated by the gasket 121.

Meanwhile, in some embodiments, the secondary battery 100 may include the cap plate 150. The cap plate 150 may include the bonding region 151. The bonding region 151 may be referred to as a partial region of the cap plate 150 that is welded to the second electrode tab 132a. In the illustrated embodiment, the bonding region 151 is exemplified as a region spaced a predetermined distance apart from the central axis C1 and having a predetermined width in the radial direction.

In some embodiments, the cap plate 150 may have the first thickness t1. Specifically, the cap plate 150 may generally have the first thickness t1 in the remaining region excluding the bonding region 151. In contrast, the bonding region 151 may have the second thickness t2. The second thickness t2 may be formed smaller than the first thickness t1 by a predetermined degree. That is, the bonding region 151 may have the second thickness t2 that is smaller than the first thickness t1 of the cap plate 150 by a predetermined degree. For example, the second thickness t2 may be formed to be 30 to 50% of the first thickness t1.

The bonding region 151 as described above may contribute to facilitating the transfer of the welding heat through the bonding region 151. As a result, the weld integrity between the bonding region 151 and the second electrode tab 132a may be ensured. In addition, when the cap plate 150 is assembled to the can 110, the bonding between the bonding region 151 and the second electrode tab 132a may be properly achieved.

In some embodiments, the cap plate 150 may be formed by processing a plate-shaped member having the first thickness t1. The bonding region 151 may be formed by press-forming a partial region of the cap plate 150 corresponding to the bonding region 151 to the second thickness t2. Specifically, the cap plate 150 may be manufactured by processing a single plate-shaped member having the first thickness t1 into a predetermined shape. For example, the cap plate 150 may be manufactured by cutting, bending, or the like of the plate-shaped member. Accordingly, the manufactured cap plate 150 may generally have the first thickness t1.

In addition, the partially processed bonding region 151 may be disposed in a partial region of the cap plate 150. The partially processed bonding region 151 may be in a pre press-forming state and may have the first thickness t1 corresponding to the cap plate 150. The partially processed bonding region 151 may be further press-formed by a predetermined pressing device. As a result, as the thickness of the partially processed bonding region 151 is reduced, the bonding region 151 having the second thickness t2 may be formed. Such a processing method may contribute to improving the manufacturability and processing convenience of the cap plate 150 and the bonding region 151.

In some embodiments, the bonding region 151 may include an inner surface 151a and an outer surface 151b. The inner surface 151a refers to a surface disposed toward the inside of the can 110, and the outer surface 151b refers to an opposite surface disposed to face the outside of the can 110 and corresponding to the inner surface 151a. The bonding region 151 may have the second thickness t2 between the inner surface 151a and the outer surface 151b. Here, welding heat may be applied to the outer surface 151b by a welding device. In addition, the inner surface 151a may be bonded to the second electrode tab 132a according to the applied welding heat.

Specifically, in some embodiments, a laser beam for applying welding heat may be irradiated onto the outer surface 151b of the bonding region 151. The welding heat irradiated onto the outer surface 151b of the bonding region 151 may be transferred to the inner surface 151a of the bonding region 151 in a thickness direction of the bonding region 151. The inner surface 151a of the bonding region 151 may be bonded to the second electrode tab 132a by the welding heat transferred in this way. For example, at least a portion of the second electrode tab 132a may be melted by the welding heat transferred from the inner surface 151a of the bonding region 151 and fused to the bonding region 151.

In some embodiments, the second thickness t2 of the bonding region 151 may contribute to smooth transfer of the welding heat as described above. That is, the bonding region 151 having a relatively small thickness may allow the welding heat irradiated onto the outer surface 151b to be sufficiently transferred to the inner surface 151a. Accordingly, the inner surface 151a of the bonding region 151 may be more completely bonded to the second electrode tab 132a. In addition, the integrity of electrical connection between the bonding region 151 and the second electrode tab 132a may be ensured.

In some embodiments, the welding between the bonding region 151 and the second electrode tab 132a may be performed with the cap plate 150 previously disposed in the opening 113. That is, the welding between the bonding region 151 and the second electrode tab 132a may be performed while the opening 113 is closed.

Meanwhile, in the present description, the term “welding” may encompass various bonding methods in which a predetermined amount of heat is applied and a base material is partially melted to bond. In addition, the welding may include a method of bonding by melting an intermediate medium such as a filler metal interposed with the base material. For example, in the present description, the welding may be used to include brazing, soldering, and the like.

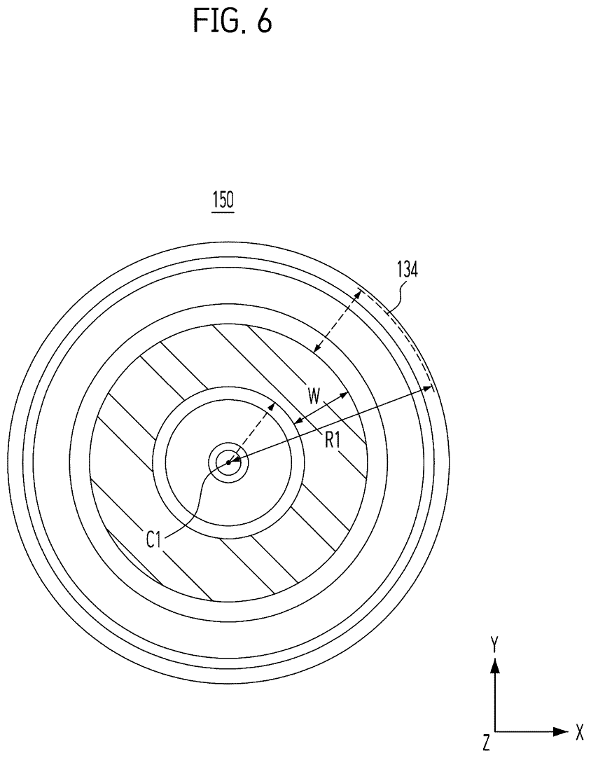

FIG. 6 is a schematic plan view of the cap plate illustrated in FIG. 4.

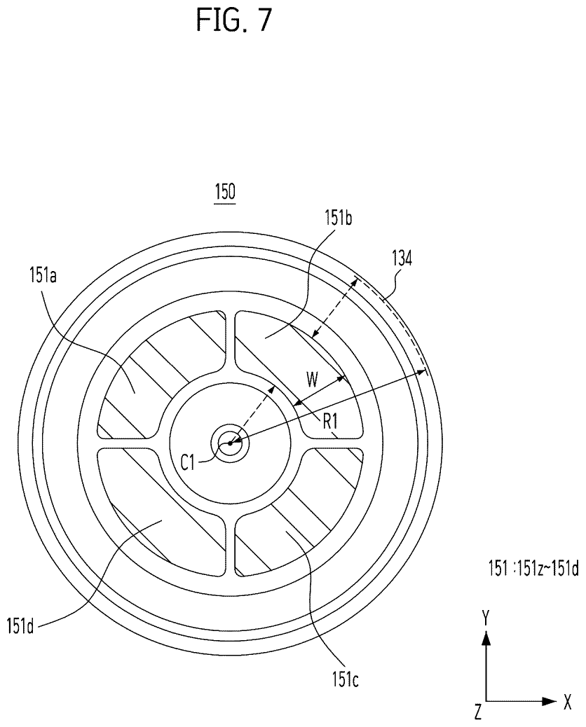

Referring to FIG. 6, in some embodiments, the bonding region 151 may be formed to extend in a circumferential direction centered on the central axis C1 of the electrode assembly 130. The bonding region 151 extending in the circumferential direction may have a shape such as a complete circle, a partial circle, or a discontinuous circle. In the illustrated embodiment, the bonding region 151 is exemplified as having a complete circular ring shape. In this case, the cap plate 150 may be electrically connected by being bonded to the second electrode tab 132a in a circular ring region corresponding to the bonding region 151. For reference, FIG. 7 described below illustrates one example of the bonding region 151 having a discontinuous circular shape.

However, the shape of the bonding region 151 is not necessarily limited to the illustrated circle. The bonding region 151 may have various shapes other than the exemplified shape as long as it is in a shape capable of appropriately electrically connecting to the second electrode tab 132a. For example, the bonding region 151 may have a polygonal shape or an irregular shape that is not specifically defined.

In some embodiments, the bonding region 151 may have a predetermined width W1 in a radial direction centered on the central axis C1 of the electrode assembly 130. That is, the bonding region 151 may have a predetermined width W1 in a radial direction in a plan view. The bonding region 151 may have the predetermined width W1 in the radial direction and extend in the circumferential direction to form a circular ring shape.

In some embodiments, the bonding region 151 may be disposed to be spaced a predetermined interval apart in a radial direction from the central axis C1 of the electrode assembly 130. The bonding region 151 may also be disposed at a predetermined interval in the radial direction from an outer peripheral end 134 of the electrode assembly 130 toward the central axis C1.

The bonding region 151 as described above may be bonded to the second bonding surface 132b in an intermediate region in the radial direction of the second bonding surface 132b. Accordingly, more robust bonding with the second bonding surface 132b and the second electrode tab 132a may be achieved. To elaborate, within the second bonding surface 132b, a region adjacent to the central axis C1 and/or a region adjacent to the outer peripheral end 134 may have a relatively non-uniform arrangement of the second electrode tab 132a. Accordingly, by allowing the bonding region 151 to be bonded to the second electrode tab 132a in a region spaced a predetermined interval from the central axis C1 and the outer peripheral end, the bonding integrity between the bonding region 151 and the second electrode tab 132a may be appropriately ensured. In addition, by performing the welding in a region in which the second electrode tab 132a relatively uniformly covers the second bonding surface 132b, the occurrence of welding by-products and damage to the electrode caused by the welding heat may be prevented.

In some embodiments, the bonding region 151 may be disposed at an interval of 10 to 40% of a radius R1 of the electrode assembly 130 from the central axis C1 of the electrode assembly 130. In addition, the bonding region 151 may be disposed at an interval of 10 to 40% of the radius R1 of the electrode assembly 130 from the outer peripheral end 134 of the electrode assembly 130.

The bonding region 151 as described above may be spaced a predetermined interval apart from each of the central axis C1 of the electrode assembly 130 and the outer peripheral end 134 of the electrode assembly 130. The bonding region 151 may also be bonded to the second electrode tab 132a in a region of about 20 to 80% of the radius R1 of the electrode assembly 130. In some embodiments, when the bonding region 151 approaches the central axis C1 or the outer peripheral end 134 at an interval of less than 10% as exemplified, welding defects or electrode damage may occur due to a non-uniform distribution of the second electrode tab 132a. In addition, when the bonding region 151 is spaced an interval of more than 40% apart from the central axis C1 or the outer peripheral end 134 as exemplified, it may be difficult to secure an appropriate electrical connection path between the second bonding surface 132b and the bonding region 151.

FIG. 7 is a schematic plan view illustrating another embodiment of the cap plate illustrated in FIG. 6.

Referring to FIG. 7, in some embodiments, the bonding region 151 may have a discontinuous form or may be divided into a plurality of bonding parts. For example, the bonding region 151 may be formed to extend in the circumferential direction centered on the central axis C1 and may be divided into a plurality of arc shapes. In the illustrated embodiment, the bonding region 151 is divided into four arcs 151a to 151d.

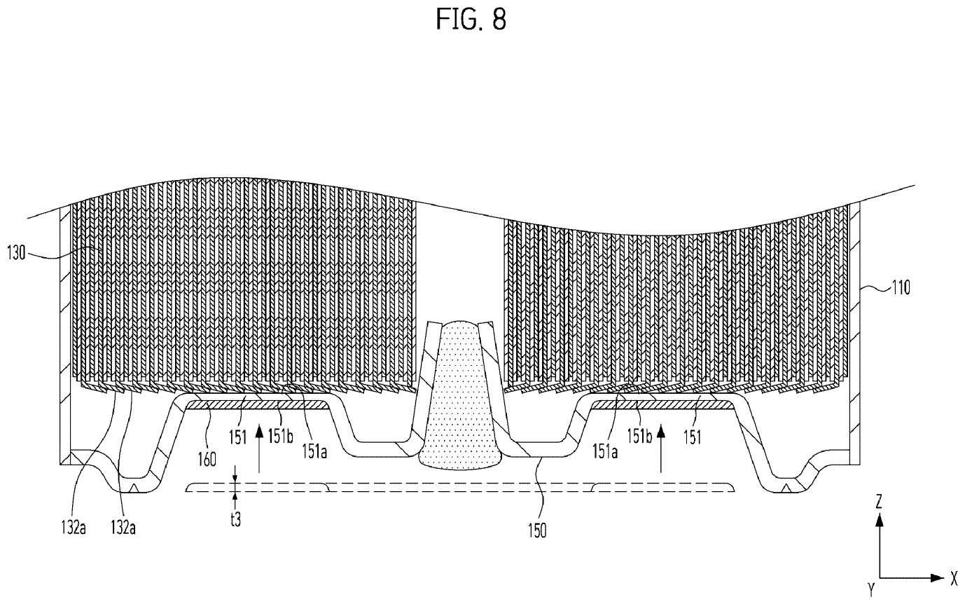

FIG. 8 is a schematic longitudinal cross-sectional view illustrating an embodiment in which a reinforcement member is added to the bonding region illustrated in FIG. 4.

Referring to FIG. 8, in some embodiments, the secondary battery 100 may further include a reinforcement member 160. The reinforcement member 160 may be fastened to the outer surface 151b of the bonding region 151 after the bonding region 151 is welded to the second electrode tab 132a. Specifically, in some embodiments, the secondary battery 100 may further include the reinforcement member 160 fastened to the bonding region 151. The reinforcement member 160 may be fastened after the welding of the bonding region 151. That is, welding heat may be applied to the outer surface 151b of the bonding region 151 to bond the bonding region 151 to the second electrode tab 132a, and thereafter, the reinforcement member 160 may be fastened to the outer surface 151b of the bonding region 151. In some embodiments, the reinforcement member 160 may be welded to the bonding region 151 or the cap plate 150. The bonding region 151 having a relatively small thickness may be appropriately reinforced through the fastening of the reinforcement member 160.

The reinforcement member 160 may have a material, a shape, a thickness, or the like capable of appropriately reinforcing the bonding region 151. In some embodiments, the reinforcement member 160 may be formed of the same material as the bonding region 151 or the cap plate 150. In addition, in some embodiments, the reinforcement member 160 may be formed such that at least a portion thereof has a third thickness t3 greater than the second thickness t2. That is, the reinforcement member 160 may be formed to be thicker than the bonding region 151. Such a reinforcement member 160 may have appropriate rigidity and function to reinforce the bonding region 151.

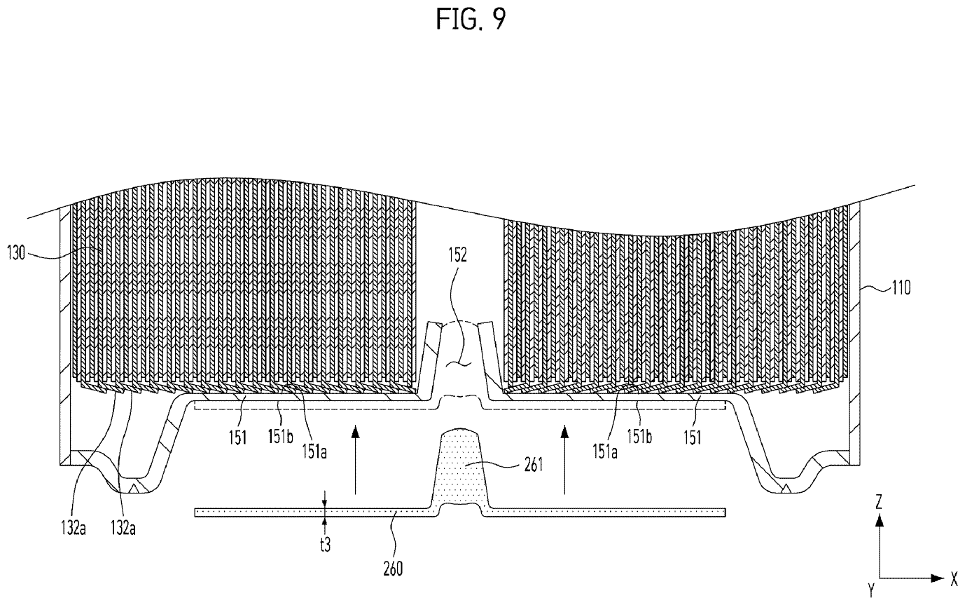

FIG. 9 is a schematic longitudinal cross-sectional view illustrating another embodiment of the reinforcement member illustrated in FIG. 8.

Referring to FIG. 9, in some embodiments, the cap plate 150 may include an inlet 152 for injecting an electrolyte into the can 110. A reinforcement member 260 may also integrally provided with a plug 261 for closing the inlet 152. Specifically, in some embodiments, the cap plate 150 may include the inlet 152. The inlet 152 may function as a passage for injecting an electrolyte into the can 110. In some embodiments, the electrolyte may be injected after the bonding region 151 and the second electrode tab 132a are bonded.

In some embodiments, the inlet 152 may be closed by the reinforcement member 260. That is, when the cap plate 150 is disposed in the opening 113 of the can 110 and the bonding region 151 and the second electrode tab 132a are bonded, the reinforcement member 260 may be fastened to the bonding region 151, thereby closing the inlet 152 by the reinforcement member 260. This method may contribute to improving manufacturability by performing the fastening of the reinforcement member 260 and the closing of the inlet 152 in a single process. In some embodiments, the reinforcement member 260 may integrally include the plug 261 for closing the inlet 152. The plug 261 may be disposed at a position corresponding to the inlet 152 and may be fastened to the inlet 152 as the reinforcement member 260 is fastened to the bonding region 151.

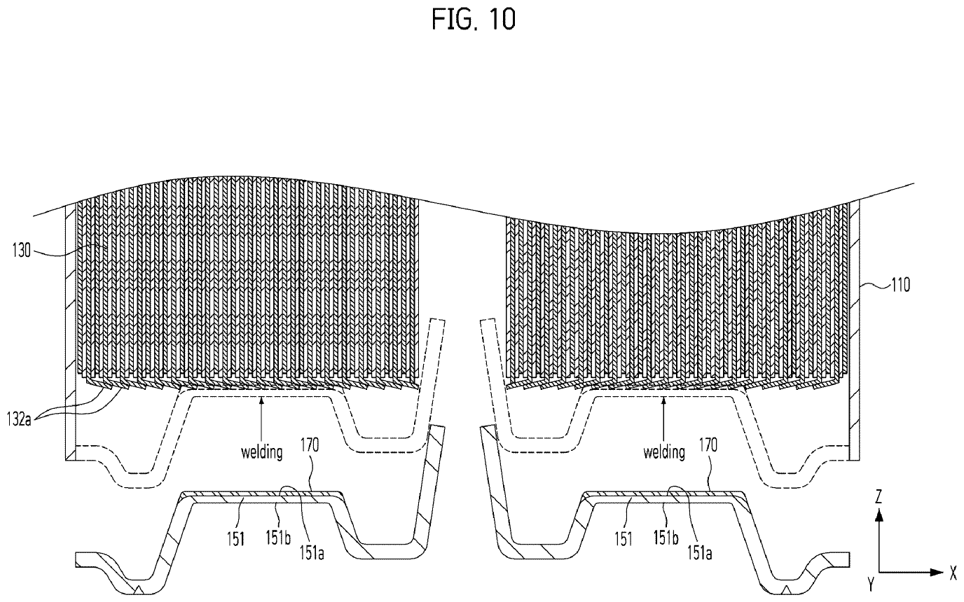

FIG. 10 is a schematic longitudinal cross-sectional view illustrating an embodiment in which a metal layer is added to the bonding region illustrated in FIG. 4.

Referring to FIG. 10, in some embodiments, the inner surface 151a of the bonding region 151 may be provided with a metal layer 170 made of a material different from the bonding region 151. Here, at least a portion of the metal layer 170 may be melted by heat applied from the welding device and bonded to the second electrode tab 132a. Specifically, the bonding region 151 may include the inner surface 151a bonded to the second electrode tab 132a, and the inner surface 151a of the bonding region 151 may be provided with the metal layer 170. The metal layer 170 may be provided on the inner surface 151a of the bonding region 151, for example, by coating, plating, or rolling. In some cases, the bonding region 151 and the metal layer 170 may be provided in the form of a clad metal.

The metal layer 170 may be melted by the welding heat and bonded to the second electrode tab 132a. That is, when welding heat is applied to the outer surface 151b of the bonding region 151, the metal layer 170 provided on the inner surface 151a of the bonding region 151 may melt, and the melted metal layer 170 may be bonded to the second electrode tab 132a. Accordingly, the bonding region 151 may be electrically connected to the second electrode tab 132a. In some embodiments, the metal layer 170 may function to reduce damage to the second electrode tab 132a caused by the welding heat. That is, the melting of the metal layer 170 may function to replace or reduce the melting of the second electrode tab 132a in the bonding between the bonding region 151 and the second electrode tab 132a. In addition, the metal layer 170 may contribute to achieving the bonding between the bonding region 151 and the second electrode tab 132a through a relatively small heat input.

In some embodiments, the metal layer 170 may include a material corresponding to the second electrode tab 132a and may be formed on the inner surface 151a of the bonding region 151 by coating, plating, rolling or the like. Specifically, in some embodiments, the metal layer 170 may be formed of a material corresponding to the second electrode tab 132a. For example, the second electrode tab 132a may include copper or a copper alloy as the material, and the metal layer 170 may be formed of copper or a copper alloy corresponding thereto. Furthermore, as described above, the metal layer 170 may be provided on the inner surface 151a of the bonding region 151 by coating, plating, rolling or the like.

Although not illustrated, in some embodiments, the metal layer 170 may be entirely provided on the inner surface of the cap plate 150. That is, the metal layer 170 may be provided on the entire inner surface of the cap plate 150, including the inner surface 151a of the bonding region 151. In such a case, the cap plate 150 may be manufactured by processing a plate-shaped member having a metal layer 170 on one surface (i.e., the inner surface) into a predetermined shape. Furthermore, an additional process for forming the metal layer 170 may be omitted.

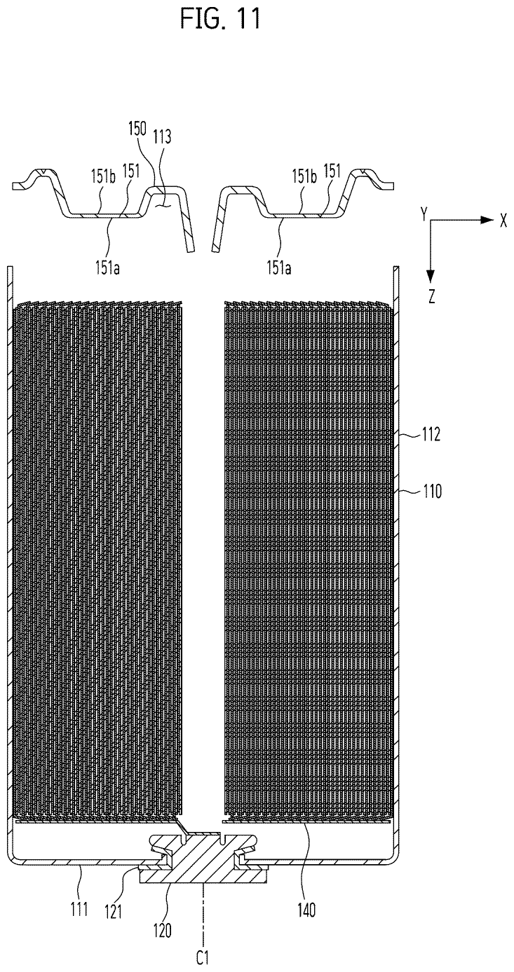

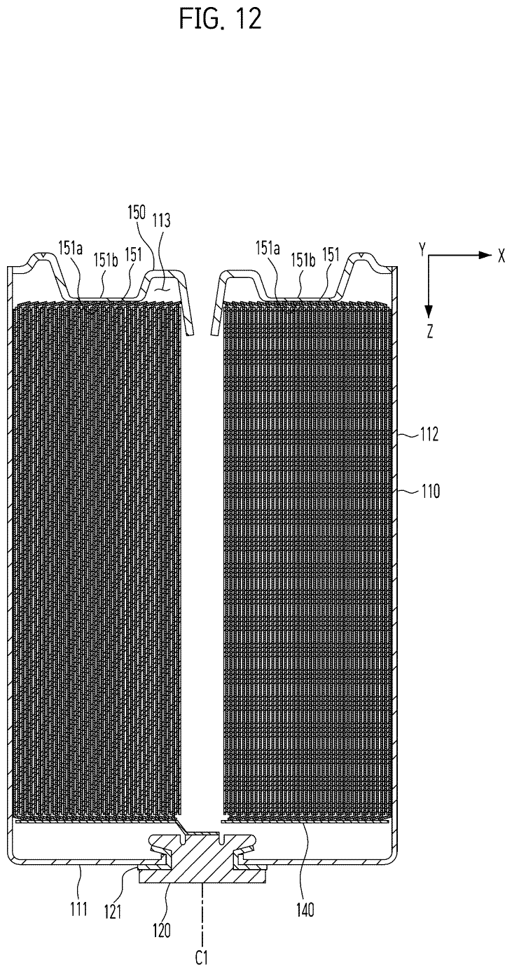

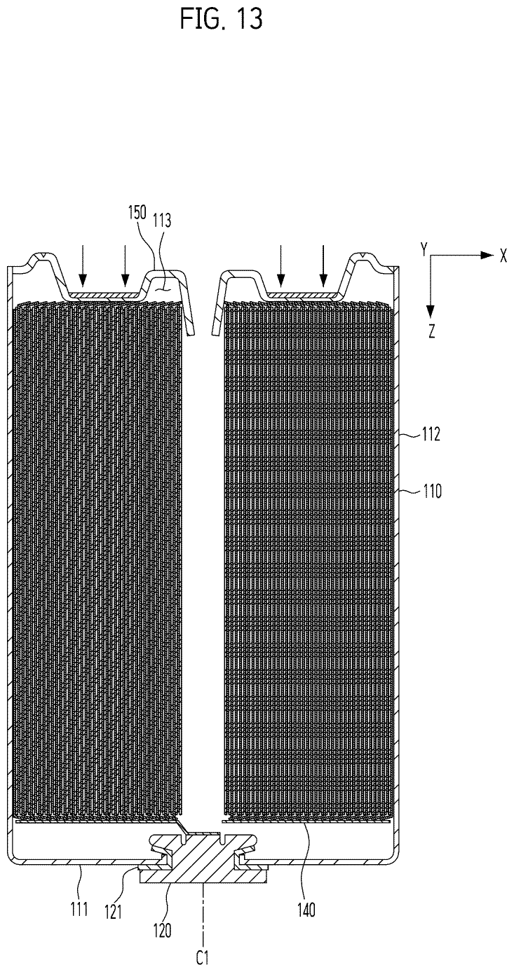

FIG. 11 is a first operational view illustrating a method of manufacturing the secondary battery according to one embodiment of the present disclosure. FIG. 12 is a second operational view illustrating the method of manufacturing the secondary battery according to one embodiment of the present disclosure. FIG. 13 is a third operational view illustrating the method of manufacturing the secondary battery according to one embodiment of the present disclosure.

According to another aspect of the present disclosure, a method of manufacturing the secondary battery may be provided. FIGS. 11 to 13 illustrate and summarize main operational states in the method of manufacturing the secondary battery according to one embodiment of the present disclosure. For convenience of description, FIGS. 11 to 13 illustrate the secondary battery shown in FIG. 1 and the like upside down.

In some embodiments, the method of manufacturing the secondary battery may include (A) inserting an electrode assembly 130 into a can 110 through an opening 113, (B) electrically connecting a rivet 120 disposed on one surface of the can 110 to a first electrode tab 131a of the electrode assembly 130, (C) closing the opening 113 with a cap plate 150, and (D) electrically connecting a bonding region 151 of the cap plate 150 to a second electrode tab 132a of the electrode assembly 130.

Here, the cap plate 150 may be formed such that at least a portion of the remaining region excluding the bonding region 151 has a first thickness t1. In addition, the bonding region 151 may be formed such that at least a portion thereof has a second thickness t2 smaller than the first thickness t1.

Specifically, referring to FIG. 11, the rivet 120 is fastened to one side of the can 110 (a lower side in the drawing), and the electrode assembly 130 may be inserted into the can 110 (operation (A)). The electrode assembly 130 may be inserted into the can 110 through the opening 113 on the side opposite to the rivet 120. In some cases, after the rivet 120 is fastened, the can 110 may be positioned upside down, and the electrode assembly 130 may then be inserted. For reference, FIG. 11 illustrates a state in which the can 110 is positioned upside down.

In some embodiments, a current collector plate 140 may be previously coupled to one side of the electrode assembly 130 (the lower side in the drawing). That is, the electrode assembly 130 may be inserted into the can 110 while being coupled to the current collector plate 140. Subsequently, the rivet 120 disposed on one surface of the can 110 may be electrically connected to the electrode assembly 130 (operation (B)). That is, the rivet 120 may be welded to the current collector plate 140 inserted into the can 110 to be electrically connected to the electrode assembly 130.

Subsequently, the cap plate 150 may be fastened to the opening 113 (operation (C)). The opening 113 may be closed by the cap plate 150. In some cases, the cap plate 150 may close the opening 113 in a temporarily assembled state to the can 110, or may close the opening 113 in a completely assembled state to the can 110 by welding or the like.

Referring to FIG. 12, subsequently, the bonding region 151 of the cap plate 150 may be electrically connected to the second electrode tab 132a (operation (D)). In some embodiments, the bonding region 151 may be directly bonded to the second electrode tab 132a by welding. Here, the cap plate 150 may have the first thickness t1 in the remaining region excluding the bonding region 151, and the bonding region 151 may have the second thickness t2 smaller than the first thickness t1. As described above, the bonding region 151 may induce appropriate fusion with the second electrode tab 132a and may ensure the reliability of the electrical connection.

In some embodiments, operation (D) may include applying welding heat to an outer surface 151b of the bonding region 151 by a welding device, and bonding an inner surface 151a of the bonding region 151 to the second electrode tab 132a according to the applied welding heat. This is similar to that described above with reference to FIGS. 4 and 5.

Although not illustrated, in some embodiments, the bonding region 151 may include the inner surface 151a disposed to face the inside of the can 110. In addition, the inner surface 151a may be provided with a metal layer 170 made of a material different from the bonding region 151. In addition, operation (D) may include applying welding heat to the outer surface 151b of the bonding region 151 by a welding device, and melting at least a portion of the metal layer 170 by the applied welding heat to bond the metal layer 170 to the second electrode tab 132a. This is similar to that described above with reference to FIG. 10.

Referring to FIG. 13, in some embodiments, the method of manufacturing the secondary battery may further include, after operation (D), fastening a reinforcement member 160 to the outer surface 151b of the bonding region 151. The reinforcement member 160 is similar to that described above with reference to FIG. 8.

As described above, the embodiments of the present disclosure may provide a secondary battery and a method of manufacturing the secondary battery.

In addition, at least some embodiments of the present disclosure may contribute to reducing manufacturing costs by simplifying components for manufacturing the secondary battery.

Further, at least some embodiments of the present disclosure may contribute to reducing assembly defects by inducing reliable bonding between the electrode tab and the bonding region.

Some embodiments of the present disclosure can provide a secondary battery and a method of manufacturing the secondary battery.

In addition, some embodiments of the present disclosure can provide a secondary battery capable of reducing manufacturing costs and a method of manufacturing the secondary battery.

In addition, some embodiments of the present disclosure can provide a secondary battery capable of reducing assembly defects and a method of manufacturing the secondary battery.

The above description is merely an example of applying the principles of the present disclosure, and other configurations may be further included without departing from the scope of the present disclosure.

What is claimed is:

1. A secondary battery comprising:
a can;
an electrode assembly disposed inside the can;
a rivet disposed on one surface of the can and electrically connected to a first electrode tab of the electrode assembly; and
a cap plate disposed on a surface opposite to the one surface, fastened to the can to close an opening of the can, and electrically connected to a second electrode tab of the electrode assembly,
wherein the cap plate includes a bonding region welded to the second electrode tab,
wherein the cap plate has at least a portion of the remaining area excluding the joining region with a first thickness, and
wherein the bonding region has at least a portion with a second thickness smaller than the first thickness.

2. The secondary battery of claim 1, wherein the can is charged with the same polarity as the second electrode tab and the cap plate.

3. The secondary battery of claim 1, wherein a plurality of first electrode tabs and a plurality of second electrode tabs are provided,
the plurality of first electrode tabs provide a first bonding surface on one surface of the electrode assembly, and
the plurality of second electrode tabs provide a second bonding surface on a surface opposite to the one surface of the electrode assembly.

4. The secondary battery of claim 3, wherein at least a portion of the second bonding surface is welded to the bonding region.

5. The secondary battery of claim 1, wherein the rivet functions as a first electrode terminal, and
one surface of the can on which the rivet is disposed is electrically insulated from the rivet such that at least a portion thereof functions as a second electrode terminal.

6. The secondary battery of claim 1, wherein the cap plate is provided by processing a plate-shaped member having the first thickness, and
the bonding region is provided by press-forming a partial region of the cap plate corresponding to the bonding region to the second thickness.

7. The secondary battery of claim 1, wherein the bonding region has a predetermined width in a radial direction centered on a central axis of the electrode assembly.

8. The secondary battery of claim 1, wherein the bonding region is disposed at a predetermined interval in a radial direction from a central axis of the electrode assembly, and is disposed at a predetermined interval in the radial direction from an outer peripheral end of the electrode assembly toward the central axis.

9. The secondary battery of claim 8, wherein the bonding region is disposed at an interval of 10 to 40% of a radius of the electrode assembly from the central axis of the electrode assembly, and disposed at an interval of 10 to 40% of the radius of the electrode assembly from the outer peripheral end of the electrode assembly.

10. The secondary battery of claim 1, wherein the bonding region is provided to extend in a circumferential direction centered on a central axis of the electrode assembly.

11. The secondary battery of claim 1, wherein the bonding region includes:
an inner surface disposed toward an inside of the can; and
an outer surface disposed toward an outside of the can and forming the second thickness between the inner surface and the outer surface,
welding heat is applied to the outer surface by a welding device, and
the inner surface is bonded to the second electrode tab according to the applied welding heat.

12. The secondary battery of claim 11, wherein a metal layer made of a material different from a material of the bonding region is provided on the inner surface, and
at least a portion of the metal layer is melted by the applied heat and bonded to the second electrode tab.

13. The secondary battery of claim 12, wherein the metal layer includes a material corresponding to the second electrode tab and is provided on the inner surface by coating, plating, or rolling.

14. The secondary battery of claim 1, further comprising a reinforcement member additionally fastened to an outer surface of the bonding region after the bonding region is welded to the second electrode tab.

15. The secondary battery of claim 14, wherein the reinforcement member has at least a portion with a third thickness greater than the second thickness.

16. The secondary battery of claim 14, wherein the cap plate includes an inlet for injecting an electrolyte into the can, and
the reinforcement member is integrally provided with a plug for closing the inlet.

17. A method of manufacturing a secondary battery, comprising:
(A) inserting an electrode assembly into a can through an opening;
(B) electrically connecting a rivet disposed on one surface of the can to a first electrode tab of the electrode assembly;
(C) closing the opening with a cap plate; and
(D) electrically connecting a bonding region of the cap plate to a second electrode tab of the electrode assembly by welding,
wherein the cap plate has at least a portion of the remaining area excluding the joining region with a first thickness, and
wherein the bonding region has at least a portion with a second thickness smaller than the first thickness.

18. The method of claim 17, wherein operation (D) includes applying welding heat to an outer surface of the bonding region by a welding device, and bonding an inner surface of the bonding region to the second electrode tab according to the applied welding heat.

19. The method of claim 17, wherein the bonding region includes an inner surface disposed toward an inside of the can,
a metal layer made of a material different from a material of the bonding region is provided on the inner surface, and
operation (D) includes applying welding heat to an outer surface of the bonding region by a welding device, and melting at least a portion of the metal layer by the applied welding heat to be bonded to the second electrode tab.

20. The method of claim 17, further comprising, after operation (D), additionally fastening a reinforcement member to an outer surface of the bonding region.
